(19) United States
(12) Patent Application Publication
(10) Pub. No.: US 2026/0147794 A1
(43) Pub. Date: May 28, 2026

(54) Systems and Methods for Contextually Refined Generative Artificial Intelligence

(71) Applicant: RingCentral, Inc., Belmont, CA (US)

(72) Inventors: Naresh Annepu, Bangalore (IN); Sushant Hiray, Redwood City, CA (US); Praneeth Bedapudi, Andhra Pradesh (IN); Mohit Tare, Bengaluru (IN)

(73) Assignee: RingCentral, Inc., Belmont, CA (US)

(21) Appl. No.: 19/050,613

(22) Filed: Feb. 11, 2025

(30) Foreign Application Priority Data
Nov. 26, 2024 (IN) 202441092096

(51) Int. Cl. G06F 16/332; G06F 16/35; G06F 16/383

(52) U.S. Cl. CPC G06F 16/3328; G06F 16/35; G06F 16/383

(57) ABSTRACT

Disclosed are systems, devices, and methods for contextually refined generative artificial intelligence (AI). The contextually refined generative AI produces domain-specific output from a Large Language Model (LLM) by dynamically adapting the LLM with directional anchors that provide context to a user submitted prompt. In particular, an automated support system determines a classification for a prompt based on metadata that is associated with the prompt, retrieves a set of trackers that is defined for the classification, and generates a context-specific output by modifying execution of the prompt by the LLM based on context that the set of trackers add to the prompt. The modified execution includes selecting between different paths that lead to different outputs for the prompt in the LLM based on the context that the set of trackers add to the prompt. The automated support system performs an automated action based on the context-specific output.

### CROSS-REFERENCE TO RELATED APPLICATIONS

This application claims priority to India Application No. 202441092096 filed Nov. 26, 2024 domestically in the country of India, the entire contents of which are incorporated herein by reference.

### TECHNICAL FIELD

The present disclosure relates to the field of Large Language Models (LLMs) and generative Artificial Intelligence (AI).

### BACKGROUND

Generative Artificial Intelligence (AI) may supplement or replace tasks that are performed by humans. The assistive applications of generative AI are many and include, for example, generating or providing answers to questions, generating new content based on a user prompt, performing tasks on behalf of humans, and/or directly interacting with humans according to best practices defined for various roles.

However, generative AI suffers from hallucinations. The hallucinations may include false information, answers that appear trustworthy or correct, correct answers that are created for an improper or different context than the submitted prompt, improperly created content based on misinterpreted words, and/or improper interactions with humans with incorrect tone, sentiment, wording, etc.

In some cases, the Large Language Model (LLM) that produces the generative AI output incorrectly interprets the training data or incorrectly applies training data from one field to generate an answer for a different field. For instance, a word may have different meanings when used in different fields, domains, or contexts. The hallucination rate may increase when a general LLM that is trained on an expansive corpus of unfocused or untargeted data is used to generate focused or targeted answers for specific applications, fields, domains, or other contexts.

### BRIEF DESCRIPTION OF THE DRAWINGS

FIG. 1 illustrates an example of dynamically adapting a Large Language Model (LLM) with directional anchors that provide context to a user submitted prompt in accordance with some embodiments presented herein.

FIG. 2 illustrates example interfaces for defining the trackers that provide context for a prompt submitted to the LLM for processing in accordance with some embodiments presented herein.

FIG. 3 presents a process for dynamically adapting a LLM with directional anchors in accordance with some embodiments presented herein.

FIG. 4 illustrates an example of generating context-specific output from queries that are dynamically modified with trackers in accordance with some embodiments presented herein.

FIG. 5 illustrates an example of generating context-specific output based on dynamically applied trackers that change the processing of content in accordance with some embodiments presented herein.

FIG. 6 illustrates an example of generating context-specific analytics, statistics, insights, or features for content of a common classification in accordance with some embodiments presented herein.

### DETAILED DESCRIPTION OF PREFERRED EMBODIMENTS

This disclosure arises from the realization that Large Language Models (LLMs) and generative Artificial Intelligence (AI) have too high of a hallucination rate to be reliably used for commercial and/or business applications. The risk of the generative AI producing an inaccurate or unreliable answer or result outweighs the cost-savings and efficiency provided by supplementing or replacing humans with the generative AI.

The current disclosure provides a technological solution for a technological problem in the fields of LLMs and generative AI. The technological solution involves automatically generating directional anchors for a LLM. The directional anchors dynamically adapt or configure a general LLM to be domain-specific for each submitted query or prompt. In particular, the technological solution includes automatically providing context for user queries or prompts before they are input to a LLM or generative AI so that the resulting output is specific or relevant to the context rather than any and all fields or domains or the field or domain for which the most training data was available when training the LLM. Automatically providing the context includes appending trackers or text input to the user submitted query or prompt in order to focus the generated output to a specific context that is associated with the user submitting the query or prompt, the content associated with the query or prompt, and/or the elements of the query or prompt.

The technical solution reduces hallucinations and improves the accuracy and reliability of the answers or content that are generated by the LLM in response to queries or prompts from users in different departments, groups, teams, or roles within an organization or enterprise. The technical solution reduces the hallucinations and improves the result accuracy and reliability by automatically tailoring the results for the domain or context that is associated with the user submitting the query or prompt without the user having to manually or explicitly specify the domain or context or even be aware that the domain or context is needed for a correct and accurate response.

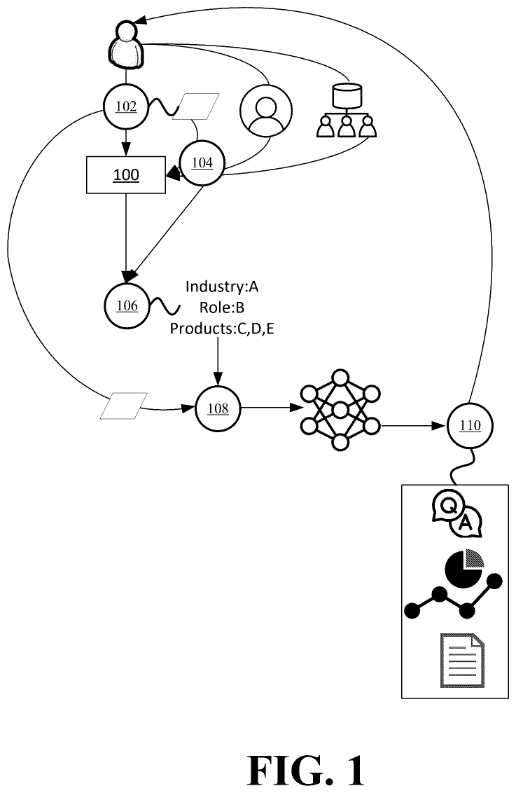

FIG. 1 illustrates an example of dynamically adapting a LLM with directional anchors that provide context to a user submitted prompt in order to produce domain-specific output from the LLM that is focused around the provided context in accordance with some embodiments presented herein. Automated support system 100 receives (at 102) a prompt for an assistive operation. The prompt may be issued by a user in one of several different departments, groups, teams, or roles within a business or enterprise. The prompt may be a text string that is formatted as a question or that includes a command or instruction. The prompt may include an image, sound file, video file, document, and/or other content with a request to query or process the content. The assistive operation may involve answering the question in the prompt, generating content according to the instructions in the prompt, processing the provided content for relevant elements, statistics, or analytics, executing a task or operation automatically based on the command specified in the prompt, and/or performing other automated actions in response to the prompt.

Automated support system 100 obtains (at 104) metadata associated with the prompt. The metadata may pertain to the user that issues the prompt. For instance, automated support system 100 may determine the user's role and the industry or classification associated with the user's role. Other metadata may be obtained (at 104) based on the text or data of the prompt. As a general example, the prompt may include the word “letter” which may be evaluated as a letter of the alphabet or a written letter. Similarly, the word “bat” may be evaluated as two different nouns such as a baseball bat or the animal. To select the correct meaning, automated support system 100 may evaluate surrounding words, content that is submitted with the prompt, and/or other data associated with the user submitting the prompt. For instance, automated support system 100 may obtain (at 104) the metadata from a profile or account of the user that may contain the user's preferences, past interactions, purchase history, browsing history, and/or other tracked user activity from which context may be extracted. As a more specific example, the prompt may be directed to a “customer issue”. However, a customer issue may have different meanings or interpretations in different domains (e.g., for customer success teams versus for customer product teams). The obtained (at 104) metadata may be used to determine if the “customer issue” relates to customer retention and is relevant to the customer success team or is an issue that the customer has with a particular product and is relevant to the customer product team.

Automated support system 100 generates (at 106) a set of trackers to associate with the prompt based on the obtained (at 104) metadata. The set of trackers may include contextual identifiers and/or qualifiers that focus the prompt and/or specific words or word combinations of the prompt to a specific domain. For instance, the contextual identifiers may specify the field or industry that the prompt pertains to, the relevant or affected group of users, the goods or services relevant to the prompt, context for certain words or word phrases, a set of actions that may be invoked by the prompt, etc. The set of trackers may also include contextual identifiers and/or qualifiers that focus the LLM's processing and/or analysis of the prompt and any included content. For instance, a first set of trackers may focus the LLM processing of a customer call on sales or billing related statistics or elements, and a second set of trackers may focus the LLM processing of the same customer call on product related statistics or elements.

Generating (at 106) the set of trackers may include appending or adding the trackers to the prompt, specific words and word combinations within the prompt, and/or content that is submitted for processing and/or analysis with the prompt. For instance, the industry identifier of “Accounting” may be added to the prompt, a link to users with an accounting role may be added to the prompt, and a contextual identifier that associates a user's payment history to the word “billing” in the prompt. As a more specific example, the prompt may be directed to a “customer issue”, the obtained (at 104) metadata may indicate that the customer recently purchased a product that is associated with a high rate of issues, and the generated (at 106) trackers may include a “common product issue/product team” directional anchor that directs the prompt to the domain for addressing the product issues. Alternatively, different metadata for the same prompt that indicates that the customer is longtime subscriber to a specific service may be used to generate (at 106) a “issues for customer retention/customer success team” directional anchor that directs the prompt a different domain.

Automated support system 100 enters (at 108) the prompt with the generated (at 106) set of trackers and/or directional anchors as input for a LLM. The LLM may be trained on data from different departments, teams, groups, and/or roles of a business or organization such that the LLM is not specialized or targeted to events or data of a single department, team, group, and/or role. The LLM is trained using machine learning, deep learning, and/or a type of neural network called a transformer model. The training allows the LLM to recognize and interpret human language or other types of complex data. In particular, the training involves modifying the matrices (e.g., assigned weights) of a neural network for understanding how characters, words, and sentences function together and performing probabilistic analysis of unstructured data to recognize distinctions between pieces of data and content without human intervention. In addition to recognizing and interpreting text, data, and other content, the matrices generate dynamic responses based on the recognition and interpretation of the text, data, and other content. The responses may be verbal, graphical, visual, or interactive. The set of trackers focus the output of the LLM to ensure that the generated output is directed to an industry, relevant users, correct word interpretation, and/or other domain specific evaluation of the prompt and/or included content. Specifically, the set of trackers direct the prompt through specific branches or paths in the neural network of the LLM so that the generated output or response to the prompt remains within the domain of the prompt.

Automated support system 100 forwards (at 110) the output generated by the LLM for the prompt and the generated (at 106) set of trackers in response to the prompt. The output may be a textual reply to a question, may be textual, visual, or audio content that is generated according to the prompt, analytics, statistics, or extracted elements from domain specific evaluation of the prompt and/or associated content, or may be an automated action that automated support system 100 performs based on instructions, commands, or queries from the prompt.

The contextual trackers that automated support system 100 appends to each prompt may be predefined or user-defined. In some example embodiments, an administrator selects the relevant industry or field associated with each user of automated support system 100. In some other example embodiments, an administrator uploads a business directory that identifies user roles within an organization or enterprise, and the relevant industry or field is automatically associated with each user based on the identified user roles. The administer may further specify categories or sub-categories under each industry or field, and/or customize or create the trackers that correspond to the contextual anchors for each industry or field and/or that provide the context for focusing or targeting the categories or sub-categories within each industry or field.

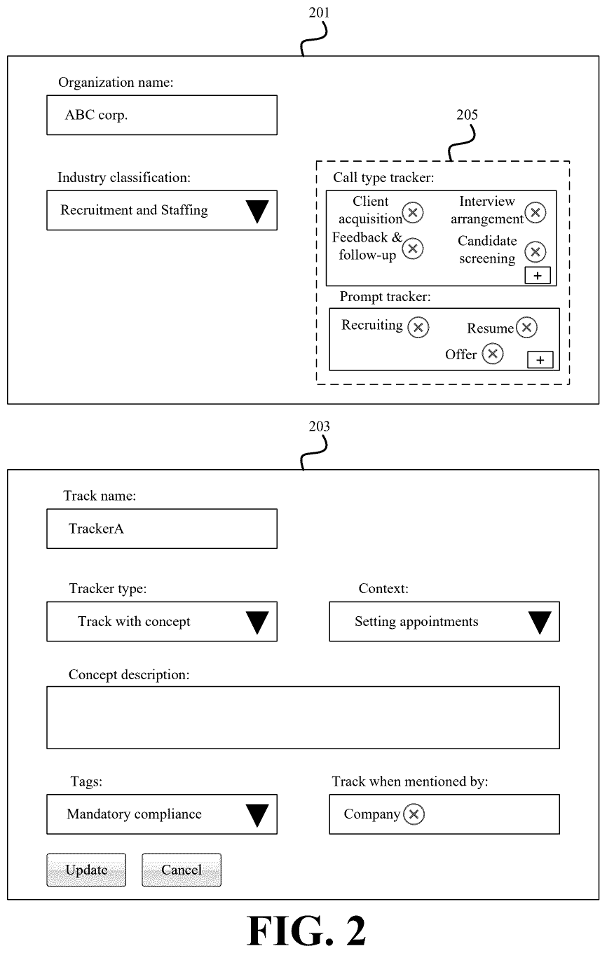

FIG. 2 illustrates example interfaces 201 and 203 for defining the trackers that provide context for a prompt submitted to the LLM for processing in accordance with some embodiments presented herein. Interface 201 is used to select and/or associate a classification to a group of one or more users. In this example, interface 201 is used to specify the industry classification for an entire organization. All users affiliated with the organization are associated with the selected industry classification and all prompts generated or associated with any of the users may be tagged with the trackers that are defined for the selected industry classification.

In some example embodiments, interface 201 is used to specify the industry classification for departments, teams, user roles, or other groups of users within the organization. The roles, departments, and/or teams may be defined in a user or employee directory. For instance, interface 201 illustrates a selection of the classification for “Recruitment and Staffing”. Interface 201 may include a series of dropdown boxes or a set of fields for specifying or selecting a top-level classification and one or more sub-classifications under the top-level classification.

Interface 201 presents trackers 205 that are defined for a selected classification. Trackers 205 may be predefined and/or user-defined. Different trackers may be defined for different actions performed by the LLM. For instance, a first set of trackers may focus the LLM analysis, evaluation, or other processing of a call or communication to a first set of statistics or elements that are relevant for the selected classification, and a second set of trackers may provide context to queries or prompts submitted to the LLM that focus or target the queries, prompts, or the words of the queries or prompts to meanings or interpretations that are consistent with the domain of the selected classification.

Automated support system 100 may also add trackers 205 to content created or exchanged by users associated with the classification that includes trackers 205. Trackers 205 are provided with the content to the LLM and serve as directional anchors that focus the manner with which the LLM processes or analyzes the content. For example, the set of trackers that are associated with the “Recruitment and Staffing” classification cause the LLM to process calls or conferences involving users associated with the “Recruitment and Staffing” classification differently than other trackers that are associated with other classifications. The different processing of calls or conferences may include generating different analytics based on different tracked events in the call or conference. For instance, the LLM may track the number of questions and type of questions that are asked by a recruiter in each call based on the set of trackers that are associated with the “Recruitment and Staffing” classification, and may track the number of subscription renewals versus cancellations in calls with users that are associated with trackers for a “Billing” classification. As another example, automated support system 100 may associate “payment inquiry” and/or “collection call” trackers to calls or communications involving a user in the organization associated with the “debt collection” classification. In particular, the trackers cause the LLM to identify parts of the calls or communications in which payment inquiries are made or discussed and/or to derive analytics based on commonality or deviations found in calls or communications with the same trackers.

Interface 201 may be used to add, remove, and/or modify trackers 205 that are associated with the selected industry classification. Adding a tracker may include selecting an add tracker input on interface 201 in order to open tracker definition interface 203. Removing a track may include selecting a removal icon or input next to each tracker that the administer wishes to remove or disassociate with an industry classification. Modifying a tracker may include selecting an existing tracker in interface 201 to open tracker definition interface 203.

Interface 203 provides fields for defining or editing a tracker. Interface 203 allows for the definition of the tracker name, the tracker type, the context associated with the tracker, a description, a tracker tag, and keywords or identifiers for tagging a call, communication, or other content with the tracker. For instance, the different fields may be used to specify the type of content that the tracker applies to, actions to perform when the tracker is detected in the content, and/or analytics to extract when the tracker is associated with a prompt or content.

Using interfaces 201 and 203, different trackers may be defined so that the same prompt is analyzed or processed differently by the LLM and/or automated support system 100. For instance, a first user and a second user with different roles in an organization may issue the same prompt related to billing data. The trackers that are associated with the first user may cause the LLM to output conversations that suggest the best prices to prospects in response to the first user having a sales or training role. The trackers that are associated with the second user may cause the LLM to output customer concerns regarding high billing value in response to the second user having support or managerial role.

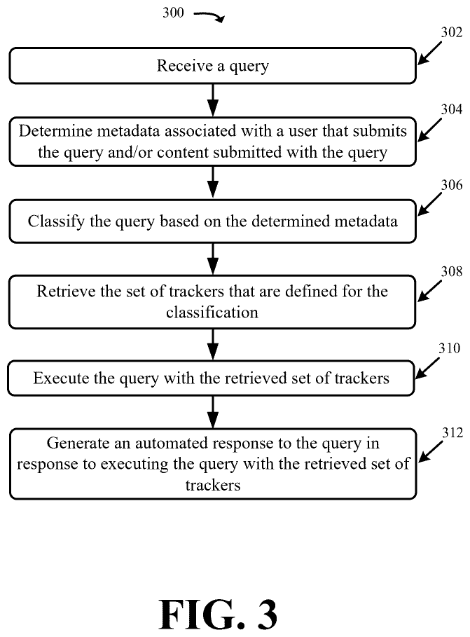

FIG. 3 presents a process 300 for dynamically adapting a LLM with directional anchors in accordance with some embodiments presented herein. Process 300 is implemented by automated support system 100.

Automated support system 100 includes one or more devices or machines with processor, memory, storage, network, and/or other hardware resources that operate in conjunction with a LLM to provide generative and/or assistive AI functionality for one or more users. In some example embodiments, automated support system 100 may integrate with calling, conferencing, billing, support, development, management, and/or other devices and systems of an organization in order to provide automated support services for users of the organization. For instance, automated support system 100 may integrate with automated dialing and/or conferencing devices or systems of agents in order to provide live automated support to the agents while they are engaged in a communication with a third-party and to provide management with analytics as to the effectiveness of each agent in their role. The generative AI may produce answers or solutions that assist human agents in the performance of their tasks. Moreover, the generative AI may be used to control automated actions that are performed without human intervention. For instance, the generative AI may be used to process audio and/or video streams of calls and conferences, extract industry-specific features from the calls and conferences based on the industry classifications associated with the calls and conferences or the participants, generate customized analytics and insights from the extract features, and perform automated actions in support of or in place of human agents. The automated actions may include directly engaging with customers or users via a chatbot that is dynamically adapted to assume the role of a human representation in a particular role based on the trackers or associated context being input to the LLM with prompts from the customers or users.

Process 300 includes receiving (at 302) a query through a graphical interface, Application Programming Interface (API), or other interface to automated support system 100. In some example embodiments, automated support system 100 may intercept the query after it is entered in the graphical interface, submitted as an API call, or entered through another interface before the query is issued to the LLM for execution.

The query may be a textual prompt, a recorded audio prompt, a video stream, and/or content that is submitted for analysis by the LLM of automated support system 100. For instance, the LLM may be used to analyze every call that is made by an agent or all agents in a department or team, to provide output for supporting the agents and/or managers in the department or team, and/or to generate automate responses on behalf of the agents to customers or other users targeted in the calls.

Process 300 includes determining (at 304) metadata associated with a user that submits the query and/or content that is submitted with the query. In some example embodiments, automated support system 100 may receive (at 302) the query from a client device, may determine the user that is associated with the client device based on a device-to-user association, login or account information of the user using the client device, one or more identifiers provided with the query, and/or other query or user tracking, and automated support system 100 may look up the role of the determined user in a directory. In some other example embodiments, automated support system 100 may receive (at 302) the query and the content associated with the content, may determine the users associated with the content, and may look up the role of the determined users in the directory. For instance, the content may be a collaborative file that multiple users worked on or audio and/or video streams of a call, conference, or other communication involving multiple participants. The users that worked on the collaborative file or that participated in the communication may be identified from the content metadata or by looking up logs of the system or service that generated or provided the content with the query. Automated support system 100 may also identify users participating in a call or conference based on the users'voice signatures, the user devices used to participate in the call or conference, and/or login information provided as each user joins the call or conference. The user roles may serve as the metadata for classifying the query. Other metadata may include the type of content that is provided with the query (e.g., an invoice, a product specification, a call from a device of a sales agent, a call from a device of a technical support agent, etc.).

Process 300 includes classifying (at 306) the query based on the determined (at 304) metadata. In some example embodiments, classifying (at 306) the query may include determining the one or more industry classifications associated with the determined (at 304) metadata. For instance, roles of identified users provided as the metadata may indicate a department, team, or group of users that is associated with a particular industry classification. In some other example embodiments, classifying (at 306) the query may include determining the query point-of-origination, and determining the industry classification associated with the query point-of-origination. For instance, the query may originate from a specific department, team, or group of an organization that is determined from the role of the user submitting the query and that is associated with a particular industry classification. In still some other embodiments, the query classification (at 306) may be based on the type of content that is included with the query, elements of the content, and/or text within the query.

Process 300 includes retrieving (at 308) the set of trackers that are defined for the classification. The set of trackers include one or more contextual identifiers for or the determined classification. For instance, a first classification may be defined with a first set of trackers that focus ambiguous terms to have specific meaning within a first domain, that specify a first set of actions or directional anchors that direct the LLM analysis of the query or the associated content through a first set of neural network branches or pathways, and/or that specify tags, features, or elements that are relevant for the first classification or analysis of content with the first classification, and a second classification may be defined with a second set of trackers that focus ambiguous terms to have a different specific meaning within a second domain, that specify a different second set of actions or directional anchors that direct the LLM analysis of the query or the associated content through a second set of neural network branches or pathways, and/or that specify tags, features, or elements that are relevant for the second classification or analysis of content with the second classification.

Process 300 includes executing (at 310) the query with the retrieved (at 308) set of trackers. Executing (at 310) the query includes appending or entering the retrieved (at 308) set of trackers with the query as inputs to the LLM. The set of trackers control or direct how the LLM processes the query by providing context to the query. In particular, the set of trackers are additional inputs that the LLM uses in deciding which neurons or paths through the neural network to traverse in order to arrive at a response or output for the query. Accordingly, executing (at 310) the query may include selecting between different paths through the LLM neural network that are valid for the text or content of query and that lead to different outputs based on the context that the set of trackers provide to the query. For instance, the words of the query may match by a threshold amount (e.g., more than 50%) to feature combinations or vectors defined along two divergent paths in the LLM. The set of trackers that are dynamically added to the query provide the additional context for increasing the match with the feature combination or vector of a particular path defined according to the same context. The particular path is associated with output that is specific to the query and the domain that is relevant to the provided context.

Process 300 includes generating (at 312) an automated response to the query in response to executing (at 310) the query with the retrieved (at 308) set of trackers. The automated response corresponds to the context-specific output that is produced from the traversed path through the LLM neural network.

The automated response may be output through a chatbot or virtual agent that communicates directly with customers or users with a specific role. For instance, the set of trackers may cause the LLM to generate (at 312) chatbot prompts to user queries that are targeted or focused to a specific domain (e.g., billing, technical support, marketing, sales, etc.) and that adhere to different communication standards and/or best practices of the specific domain. The automated response may include performing different automated actions based the set of trackers targeting the response to a specific domain. For instance, the query may state “Let me speak to a supervisor”. The automated response that is generated (at 312) for this query tagged with a first set of trackers may include automatically connecting the user submitting the query to a supervisor in a first department (e.g., billing), and the automated response that is generated (at 312) for the same query tagged with a second set of trackers may include automatically connecting the user submitting the query to a different supervisor in a second department (e.g., technical support) without the user having the specify which department the supervisor should operate in. The automated response may include dynamically generated content (e.g., presentation, documentation, reports, analysis, etc.) that is domain specific. For instance, the query may request a budget report and a first set of trackers may focus the budget report on expenses that are specific to a first team or group and a second set of trackers may focus the budget report on expenses that are specific to a second team or group.

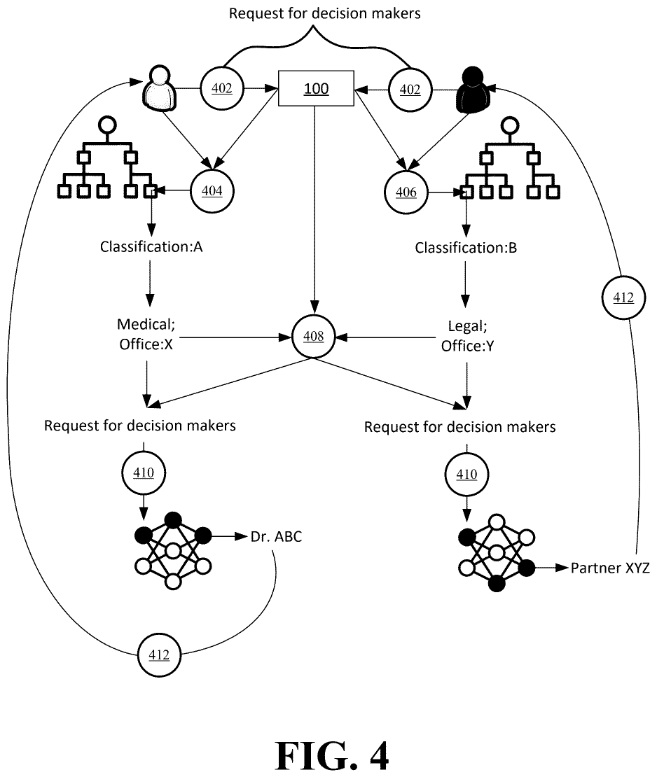

FIG. 4 illustrates an example of generating context-specific output from queries that are dynamically modified with trackers in accordance with some embodiments presented herein. Automated support system 100 receives (at 402) the same query from two different users in an organization. The query is a textual prompt requesting an identification of decision makers.

Automated support system 100 determines (at 404) that the first query is originated by a first user that is associated with a first classification due to the first user having a first role in an organization, operating in a first department, or being part of a first team. Automated support system 100 determines (at 406) that the second query is originated by a second user that is associated with a second classification due to the second user having a second role in an organization, operating in a second department, or being part of a second team.

Automated support system 100 retrieves (at 408) different trackers that are defined for or associated with the first classification and the second classification. The trackers provide different context that is specific to the first classification and the second classification and that clarifies the otherwise ambiguous term of decision-makers within each classification.

Automated support system 100 executes (at 410) the first query with the trackers that are retrieved (at 408) for the first classification and executes (at 410) the second query with the trackers that are retrieved (at 408) for the second classification using the same LLM. The trackers change the execution (at 410) of each query by changing the pathways that are traversed in the LLM neural network. For instance, the term “decision-maker” in each query results in diverging paths as the term is qualified with different trackers in each query.

Consequently, the output produced by the LLM for each query is different despite the queries having the same text or prompt. Automated support system 100 provides (at 412) the different results for each query to the user that submitted that query.

The dynamically added trackers allow users to submit queries without having extensive knowledge as to how the LLM interprets or processes the queries, without having to explicitly or manually provide the necessary context for the queries, and/or without having to route queries between different context-specific or domain-specific LLMs. As a result, the dynamically added trackers reduce the LLM hallucination rate and/or the rate of answers or output that are true but not accurate. The accuracy of the LLM output is greatly increased relative to queries that are submitted without the dynamically added trackers.

The generative AI may use the trackers to generate new and different insights or analytics from the same content for different users, roles, or teams in an organization. For instance, sales managers and product or marketing managers may be interested in different aspects of calls or communications made by sales representatives. The sales managers may be interested in discovering best practices that result in completed sales, subscription renewals, or product or service upgrades. The product or marketing managers may be in interested in specific elements of a product or service that customers like or dislike for improving future products or services. The trackers may be used to modify the LLM processing of the calls or communications and to extract the relevant call features or statistics for the different managers.

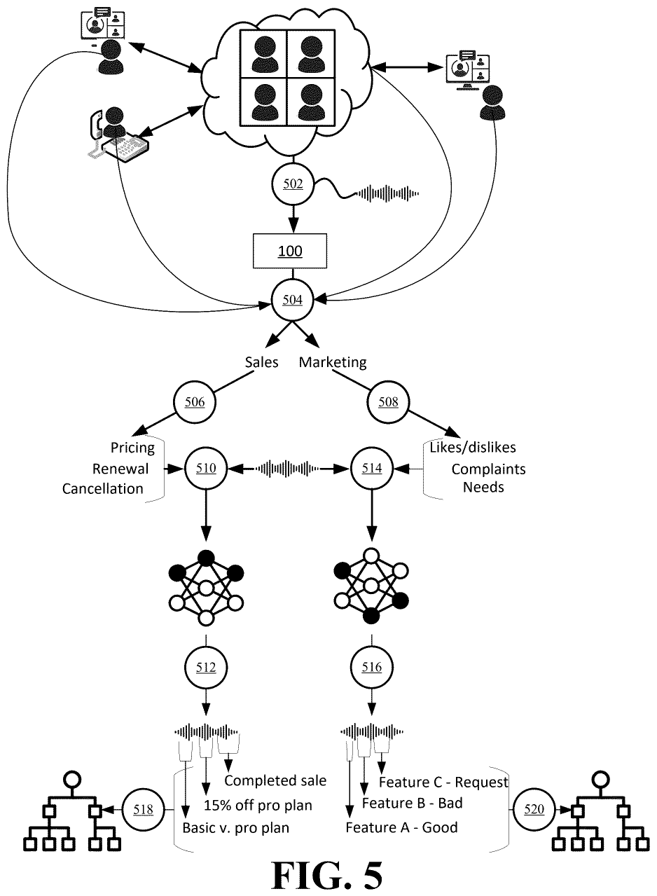

FIG. 5 illustrates an example of generating context-specific output based on dynamically applied trackers that change the processing of content in accordance with some embodiments presented herein. Automated support system 100 receives (at 502) content for LLM processing and/or analysis. The content may include the audio and/or video streams of a conference involving two or more participants, files exchanged between the two or more participants during the conference, and/or textual messages exchanges before, during, and after the conference.

Automated support system 100 identifies (at 504) two distinct classifications that are associated with the content. Automated support system 100 may identify (at 504) the classifications based on users that were involved in the generation, editing, or submission of the content, the roles, departments, or teams that the users are part of, the conference type, the type of content that is exchanged during the conference, and/or user or content related attributes. For instance, the content may be a recorded call between a sales agent and a customer (e.g., an existing customer or a potential new customer). The call may associated with a sales classification and a marketing classification.

Automated support system 100 obtains (at 506) a first set of trackers that are defined for or associated with the identified (at 504) first classification. The first set of trackers may include context or identifiers for a first set of elements from the call that are important or relevant for processing or analyzing the call for members of the first classification.

Similarly, automated support system 100 obtains (at 508) a second set of trackers that are defined for or associated with the identified (at 504) second classification. The second set of trackers may include context or identifiers for a different second set of elements from the call that are important or relevant for processing or analyzing the call for members of the second classification.

Automated support system 100 generates (at 510) a first prompt for a first context-specific processing or analysis of the call by the LLM that is directed towards or focused on the first set of trackers. Automated support system 100 receives (at 512) first output created from the LLM processing or analyzing of the call with the first context specified through the first set of trackers.

Automated support system 100 generates (at 514) a second prompt for a different second context-specific processing or analysis of the call by the LLM that is directed towards or focused on the second set of trackers. Automated support system 100 receives (at 516) second output created from the LLM processing or analyzing of the call with the second context specified through the second set of trackers.

The first output may include analytics, statistics, insights, or features extracted or derived from the call that are related or relevant to the context or directional anchors specified in the first set of trackers, and the second output may include analytics, statistics, insights, or features extracted or derived from the call that are related or relevant to the context or directional anchors specified in the second set of trackers. Accordingly, the different sets of trackers cause the LLM to process or analyze the same call differently and to generate different analytics, statistics, insights, or features from the call.

Automated support system 100 presents (at 518) the first output to members of the first classification that request access to the analysis of the call, and presents (at 520) the second output to members of the second classification that request access to the analysis of the call. In some example embodiments, automated support system 100 links the first output to the call and the first classification, and links the second output to the call and the second classification so that the different outputs may be easily retrieved and presented (at 518 or 520) to the users of the correct classification.

Automated support system 100 may aggregate the output that is generated for different content under the same classification or for the same content, may analyze the aggregated output to detect trends, patterns, and/or commonality amongst the output, and may generate consolidated and/or advanced context-specific analytics, statistics, insights, or features for the content that is relevant to the common classification. Moreover, users may generate queries to execute against the aggregated output for content of the common classification rather than the output that is generated for specific content. The queries may be used to generate customized analytics, statistics, or insights that are relevant for the similarly classified content.

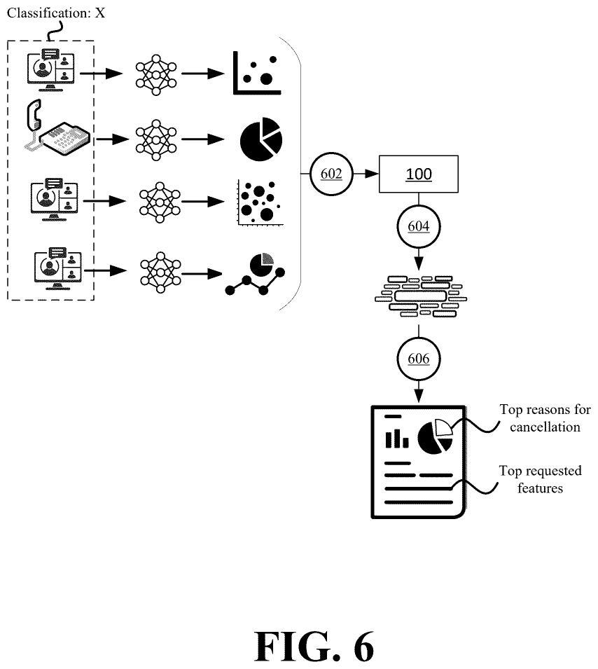

FIG. 6 illustrates an example of generating context-specific analytics, statistics, insights, or features for content of a common classification in accordance with some embodiments presented herein. Automated support system 100 selects (at 602) context-specific output that the LLM generates for different content with a common classification. In this example, automated support system 100 selects (at 602) the output that is generated for calls or communications relating to a subscription or service cancellation. Accordingly, the analyzed set of content includes calls or communications that mention the words “cancel”, “refund”, “stop service”, or “return”, that changed an account status to inactive or closed, and/or that resulted in a payment being issued to the customer. The generated content includes statistics for the canceled product or service, negative adjectives used to describe the product or service, pricing statistics, timing (e.g., duration of a subscription) statistics, and/or other tracked, measured, or extracted features from the calls.

Automated support system 100 detecting (at 604) patterns, trends, and/or commonality amongst the selected (at 602) output. The detected (at 604) patterns, trends, and/or commonality may include frequently occurring statistics or features or statistics or features that repeat by a threshold amount across the selected (at 602) output.

Automated support system 100 generates (at 606) advanced insights from the detected (at 604) patterns, trends, and/or commonality. For instance, automated support system 100 may identify the most common reason for subscription or service cancellation, thereby allowing management to make adjustments that resolve the customer reasons for the subscription or service cancellation.

Automated support system 100 presents the advanced insights in a graphical interface in response to a user prompt or query for the advanced insights or in response to a trend, pattern, or commonality that is detected in a threshold amount or percentage of the analyzed content. For instance, the user prompt may request the top 5 reasons why customers are canceling a particular product. Automated support system 100 searches the advanced insights to isolate the patterns or trends related to cancellation of the particular product, and presents the isolated patterns or trends in response the user prompt. The user prompt may trigger additional processing of the advanced insights or output, and create specific output combinations or a specific ordering or presentation for a subset of the output.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments. It should be understood, that terms “user” and “participant” have equal meaning in the following description.

1. A computer-implemented method for dynamically adapting a Large Language Model (LLM) for targeted output in different domains, the computer-implemented method comprising:
receiving a prompt for the LLM;
determining a classification based on metadata that is associated with the prompt;
retrieving a set of trackers that is defined for the classification;
generating a context-specific output by modifying execution of the prompt by the LLM based on context that the set of trackers add to the prompt, wherein modifying the execution comprises selecting between different paths that lead to a plurality of different outputs for the prompt in the LLM based on the context that the set of trackers add to the prompt; and
performing an automated action in response to the prompt based on the context-specific output.

2. The computer-implemented method of claim 1, further comprising:
defining the metadata based on a role of a user that submits the prompt.

3. The computer-implemented method of claim 1, further comprising:
defining the metadata based on one or more users that participant in a communication identified in the prompt.

4. The computer-implemented method of claim 1, further comprising:
presenting an interface comprising different fields for adding, removing, and modifying the set of trackers associated with the classification.

5. The computer-implemented method of claim 1, further comprising:
defining a plurality of classifications in a graphical user interface;
associating the plurality of classifications to different user roles or types of content; and
defining a different set of trackers for each classification of the plurality of classifications based on inputs provided in the graphical user interface.

6. The computer-implemented method of claim 1, further comprising:
generating a modified prompt by appending the set of trackers to the prompt prior to executing the prompt with the LLM; and
issuing the modified prompt instead of the prompt as input to the LLM.

7. The computer-implemented method of claim 1, further comprising:
dynamically enhancing the prompt with first context defined by a first set of trackers in response to determining a first classification; and
dynamically enhancing the prompt with second context defined by a second set of trackers in response to determining a second classification.

8. The computer-implemented method of claim 1, wherein generating the context-specific output comprises:
generating an answer to a question in the prompt with data from a particular domain associated with the classification and by excluding data from other domains that are associated with other classifications.

9. The computer-implemented method of claim 1, wherein generating the context-specific output comprises:
selecting a response from a plurality of responses that replies to a first contextual interpretation of the prompt based on the classification, and wherein each other response from the plurality of response is a reply to a different contextual interpretation of the prompt.

10. The computer-implemented method of claim 1, wherein generating the context-specific output comprises:
determining one or more features of the prompt that ambiguously reference different data in different domains; and
resolving the one or more features to a particular domain from the different domains based on the context that the set of trackers add to the prompt.

11. The computer-implemented method of claim 1, wherein performing the automated action comprises:
activating a chatbot; and
responding directly to the prompt with the context-specific output from the chatbot.

12. The computer-implemented method of claim 1, wherein generating the context-specific output comprises:
extracting a first set of features from audio content of a conference identified in the prompt based a relevance between the first set of features and a first set of trackers defined for a first classification; and
extracting a different second set of features from the audio content based a relevance between the different second set of features and a second set of trackers defined for a second classification.

13. The computer-implemented method of claim 1, further comprising:
training the LLM with data from different departments of an organization; and
wherein generating the context-specific output comprises:
determining that the prompt relates to a particular department of the different departments based on the context that the set of trackers add to the prompt; and
generating a response to the prompt using the data from the particular department in response to determining that the prompt relates to the particular department.

14. A system for dynamically adapting a Large Language Model (LLM) for targeted output in different domains, the system comprising:
one or more hardware processors configured to:
receive a prompt for the LLM;
determine a classification based on metadata that is associated with the prompt;
retrieve a set of trackers that is defined for the classification;
generate a context-specific output by modifying execution of the prompt by the LLM based on context that the set of trackers add to the prompt, wherein modifying the execution comprises selecting between different paths that lead to a plurality of different outputs for the prompt in the LLM based on the context that the set of trackers add to the prompt; and
perform an automated action in response to the prompt based on the context-specific output.

15. The system of claim 14, wherein the one or more hardware processors are further configured to:
define the metadata based on a role of a user that submits the prompt.

16. The system of claim 14, wherein the one or more hardware processors are further configured to:
define the metadata based on one or more users that participant in a communication identified in the prompt.

17. The system of claim 14, wherein the one or more hardware processors are further configured to:
present an interface comprising different fields for adding, removing, and modifying the set of trackers associated with the classification.

18. The system of claim 14, wherein the one or more hardware processors are further configured to:
define a plurality of classifications in a graphical user interface;
associate the plurality of classifications to different user roles or types of content; and
define a different set of trackers for each classification of the plurality of classifications based on inputs provided in the graphical user interface.

19. The system of claim 14, wherein the one or more hardware processors are further configured to:
generate a modified prompt by appending the set of trackers to the prompt prior to executing the prompt with the LLM; and
issue the modified prompt instead of the prompt as input to the LLM.

20. A non-transitory computer-readable medium storing program instructions that, when executed by one or more hardware processors of a system that dynamically adapts a Large Language Model (LLM) for targeted output in different domains, cause the system to perform operations comprising:
receiving a prompt for the LLM;
determining a classification based on metadata that is associated with the prompt;
retrieving a set of trackers that is defined for the classification;
generating a context-specific output by modifying execution of the prompt by the LLM based on context that the set of trackers add to the prompt, wherein modifying the execution comprises selecting between different paths that lead to a plurality of different outputs for the prompt in the LLM based on the context that the set of trackers add to the prompt; and
performing an automated action in response to the prompt based on the context-specific output.
